(19) United States
(12) Patent Application Publication
(10) Pub. No.: US 2010/0198552 A1
(43) Pub. Date: Aug. 5, 2010

(54) Camber Tracking System

(75) Inventors: William R. W. Wick, Hamilton, OH (US); Daniel S. Cope, West Chester, OH (US)

Correspondence Address: THOMPSON HINE L.L.P.;Intellectual Property Group, P.O. BOX 8801, DAYTON, OH, 45401-8801, US

(73) Assignee: AMERICAN INDUSTRIAL METROLOGY, INC., Hamilton, OH (US)

(21) Appl. No.: 12/758,224

(22) Filed: Apr. 12, 2010

Related U.S. Application Data
(62) Division of application No. 12/480,078, filed on Jun. 8, 2009.
(60) Provisional application No. 61/059,498, filed on Jun. 6, 2008.

(51) Int. Cl. G06F 15/00

(52) U.S. Cl. 702/150

(57) ABSTRACT

An edge detection system including an elongated sheet defining a longitudinal axis and having at least one edge and a sensor positioned relative to the elongated sheet, the sensor defining a scan field having a null zone, wherein the sensor is moveable relative to the sheet in a direction generally perpendicular to the longitudinal axis to align the null zone with the edge.

### PRIORITY

This application is a divisional application of U.S. Ser. No. 12/480,078 filed on Jun. 8, 2009, which claims priority from U.S. Ser. No. 61/059,498 filed on Jun. 6, 2008. The entire contents of both the '078 and the '498 applications are incorporated herein by reference.

### FIELD

This patent application is directed to systems and methods for detecting the edge of a moving sheet and, more particularly, to edge detection systems for tracking the camber of a moving sheet.

### BACKGROUND

Referring to FIG. 1, an elongated rolled sheet 8, such as a sheet of hard-rolled or soft-rolled steel, often includes a camber C, thereby providing the rolled sheet 8 with a substantially arcuate configuration in top view. The camber C may be defined as the deviation of a side edge 6 of the rolled sheet 8 from a straight line 4. Therefore, a measurement of camber C may be presented as a distance (e.g., 2 inches) between the side edge 6 and the straight line L, wherein the distance is taken at the center of a section of the rolled sheet 8 having a predefined length (e.g., 20 ft).

It is often desirable to know the magnitude of the camber C in a rolled sheet 8. For example, unknown or excessive camber C in a rolled sheet 8 may disable or even damage equipment and machinery used to process the rolled sheet. Furthermore, if the camber C is known, various techniques may be employed to remove or at least minimize the camber C, thereby improving process efficiency and reducing the waste associated with trimming sheets to remove the camber C.

However, prior art techniques for measuring camber typically require removing a section of the rolled sheet from the line, cutting the rolled sheet section to a predetermined length, determining the center of the length of the rolled sheet section and, using a straight edge or the like, measuring the deviation of the side edge from the straight edge. Such techniques are time consuming and fail to provide real-time data.

Accordingly, there is a need for a system and method for detecting the edge of a moving sheet and, in particular, an edge detection system for tracking the camber of a moving sheet in real-time.

### SUMMARY

In one aspect, the disclosed edge detection system may include an elongated sheet defining a longitudinal axis and having at least one edge and a sensor positioned relative to the elongated sheet, the sensor defining a scan field having a null zone, wherein the sensor is moveable relative to the sheet in a direction generally perpendicular to the longitudinal axis to align the null zone with the edge.

In another aspect, the disclosed edge detection system may include an elongated sheet defining a longitudinal axis and having at least one edge, a rail disposed over at least a portion of the elongated sheet, the rail extending generally perpendicular to the longitudinal axis, and a high speed profile sensor connected to the rail, the sensor defining a scan field having a null zone, wherein the sensor is moveable along the rail to align the null zone with the edge.

In another aspect, the disclosed camber tracking system may include an elongated sheet having a first edge and a second edge, wherein the elongated sheet is moving in a traveling direction along a longitudinal axis, a first edge detecting station comprising a first sensor and a second sensor, wherein the first sensor is positioned relative to the first edge of the elongated sheet and defines a first scan field having a first null zone, the first sensor being moveable relative to the elongated sheet generally perpendicular to the longitudinal axis to align the first null zone with the first edge, and wherein the second sensor is positioned relative to the second edge of the elongated sheet and defines a second scan field having a second null zone, the second sensor being moveable relative to the elongated sheet generally perpendicular to the longitudinal axis to align the second null zone with the second edge, a second edge detection station displaced from the first edge detection station by a first distance in the traveling direction, the second edge detection station comprising a third sensor positioned relative to the first edge of the elongated sheet, the third sensor defining a third scan field having a third null zone and being moveable relative to the elongated sheet generally perpendicular to the longitudinal axis to align the third null zone with the first edge, and a third edge detection station displaced from the second edge detection station by a second distance in the traveling direction, the third edge detection station comprising a fourth sensor positioned relative to the first edge of the elongated sheet, the fourth sensor defining a fourth scan field having a fourth null zone and being moveable relative to the elongated sheet generally perpendicular to the longitudinal axis to align the fourth null zone with the first edge.

Other aspects of the disclosed edge detection system and related camber tracking system will become apparent from the following detailed description, the accompanying drawings and the appended claims.

### BRIEF DESCRIPTION OF THE DRAWINGS

FIG. 1 is a top plan view of an elongated rolled sheet material having a camber formed therein;

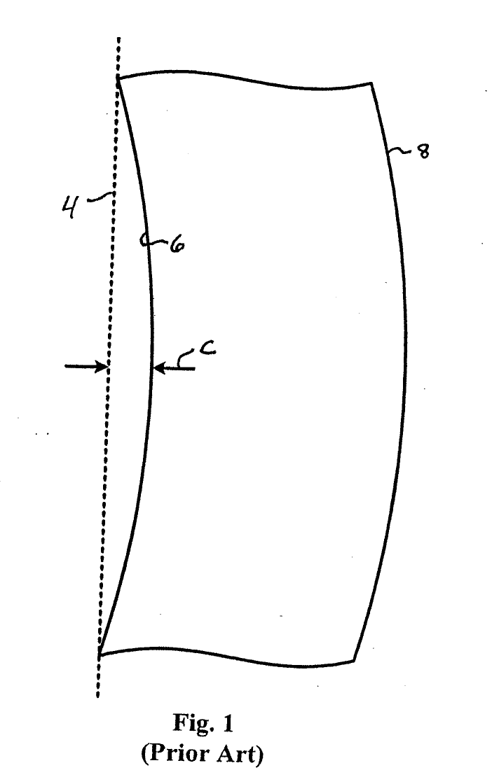

FIG. 2 is a top plan view of one aspect of the disclosed edge detection system;

FIG. 3 is a machine directional view of the edge detection system of FIG. 2; and

FIG. 4 is a top plan view of one aspect of the disclosed system for tracking camber using the disclosed edge detection system.

### DETAILED DESCRIPTION

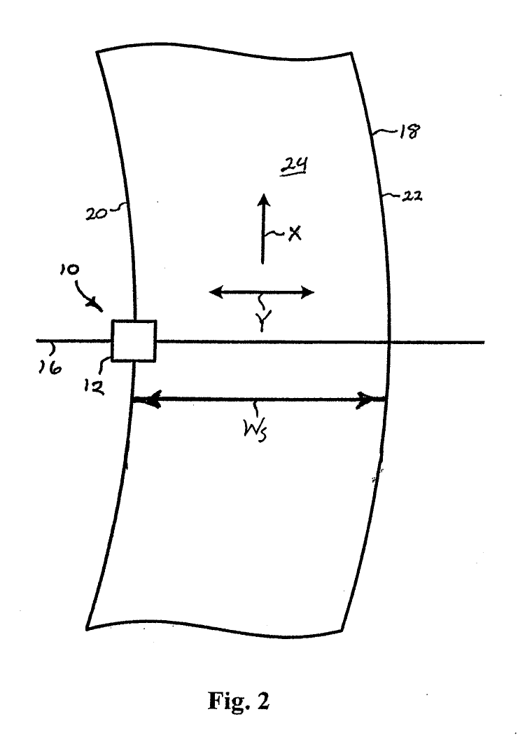

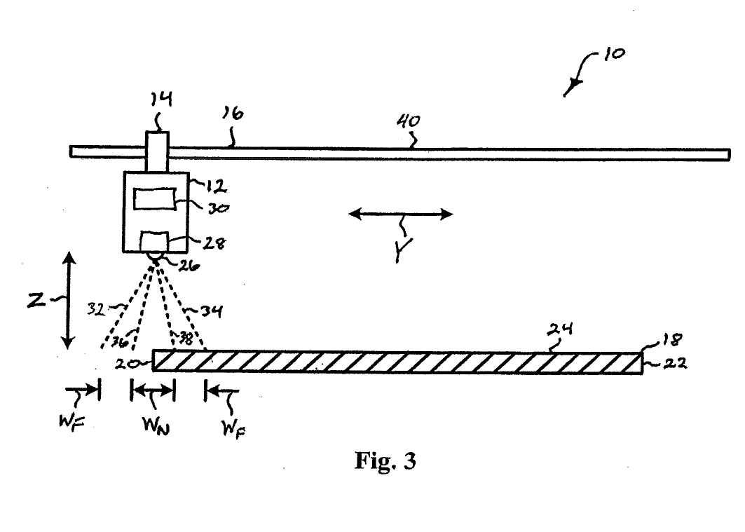

Referring to FIG. 3, one aspect of the disclosed edge detection system, generally designated 10, may include a sensor 12, an articulation device 14 and a rail 16. As shown in FIGS. 2 and 3, the system 10 may be positioned over a sheet 18 having a width W_{S}, a first longitudinal edge 20, a second longitudinal edge 22 and an upper surface 24. For example, the width W_{S} of the sheet 18 may range from about 24 inches to over 8 feet. The sheet 18 may be an elongated sheet of rolled material, such as hot-rolled steel or cold-rolled steel, and may be moving in the longitudinal direction shown by arrow X (FIG. 2), which may define the x-axis of the system 10.

The sensor 12 may be any sensor capable of identifying an edge 20, 22 of the sheet 18 when the sensor 12 is positioned relative to the sheet 18. In one aspect, the sensor 12 may be a point laser sensor. In another aspect, the sensor 12 may be a laser line sensor. An example of a sensor 12 useful with the disclosed system 10 is the scanCONTROL 2810 high speed profile sensor available from Micro-Epsilon of Ortenburg, Germany. However, those skilled in the art will appreciate that other sensors, such as non-laser-based sensors (e.g., optical sensors), may be used without departing from the scope of the present disclosure.

In one aspect, the sensor 12 may include an emitter 26, a receiver 28 and a processor (or control device) 30. In response to signals from the processor 30, the emitter 30 may emit energy, such as light, particularly laser light, that may define a scan field shown by lines 32, 34. The receiver 28 may receive reflected energy from the scan field 32, 34 and may communicate appropriate data to the processor 30.

The scan field 32, 34 may have a width W_{F} in the y-axis (arrow Y), which may be a function of the distance, in the z-axis (arrow Z), between the sensor 12 and the upper surface 24 of the sheet 18. Within the scan field 32, 34 may be a null zone shown by lines 36, 38. The null zone 36, 38 may be substantially centered in the scan field 32, 34 and may have a width W_{N} in the y-axis (arrow Y), which may be a function of the distance, in the z-axis (arrow Z), between the sensor 12 and the upper surface 24 of the sheet 18. For example, when the sensor 12 is about 12 inches away from the upper surface 24 of the sheet 18, the scan field 32, 34 may have a width W_{F} of about 5 inches and the null zone 36, 38 may have a width W_{N} of about 2 inches.

The articulation device 14 may connect the sensor 12 to the rail 16 such that the sensor 12 may move relative to the sheet 18 in the y-axis (arrow Y). In one aspect, the articulation device 14 may articulate the sensor 12 along the rail 16 relative to a known center point 40. Furthermore, the articulation device 14 may articulate the sensor 12 along the rail 16 in predefined stages, such as, for example, increments of 0.001 inches. Therefore, the precise axial location of the sensor 12 on the rail 16 may be determined at any given time.

In one aspect, the articulation device 14 may be a servo motor or like device operatively connected to the rail 16. While not shown, the engagement between the articulation device 14 and the rail 16 may be a sliding engagement, a rack-and-gear engagement, a wheel-and-track engagement or the like. In response to signals received from the processor 30, the servo motor may translate rotational power from the motor into axial movement of the sensor 12 along the rail 16 in the y-axis (arrow Y).

It should be noted that while the articulation device 14 is shown as being external of and connected to the sensor 12, those skilled in the art will appreciate that the articulation device 14 may be integral with the sensor 12. Furthermore, while the processor 30 is shown and described herein as being integral with the sensor 12, those skilled in the art will appreciate that the processor 30, or an additional processor, may be external of the sensor 12 such that the sensor 12 may communicate with the processor 30 by way of communications lines (not shown). For example, in an alternative aspect, the processor 30 may be a stand-alone computer processor that communicates with the sensor 12 and the articulation device 14 by way of physical or wireless communication lines.

Accordingly, as shown in FIG. 3, the system 10 may detect the edge 20 of the sheet 18 by controlling the axial position of the sensor 12 along the y-axis (arrow Y), as described above, such that the edge 20 of the sheet 18 remains in the null zone 36, 38 of the sensor 12. Therefore, a precise indication of the location of the edge 20 of the sheet 18 may be obtained by combining (1) the position of the sensor 12 on the rail 16 relative to the center point 40 and (2) the scan data obtained from the null zone 36, 38 of the sensor 12.

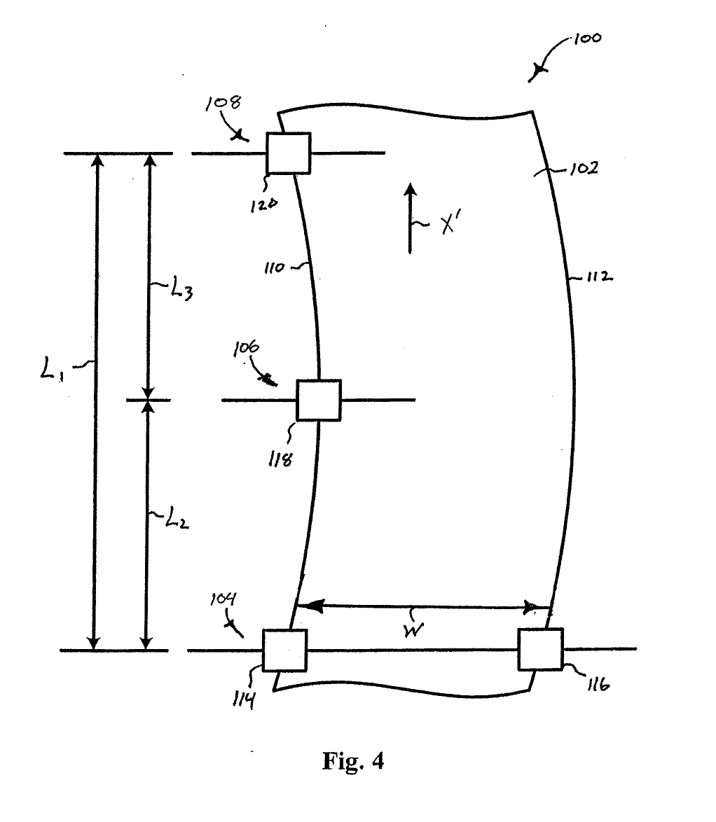

Referring to FIG. 4, a system for tracking camber, generally designated 100, may employ the disclosed edge detection system 10. In one aspect, the camber tracking system 100 may include a moving sheet 102, a first edge detection station 104, a second edge detection station 106 and a third edge detection station 108. The sheet 102 may move in the longitudinal direction shown by arrow X′ and may include a first side edge 110 and a second side edge 112. Furthermore, the sheet 102 may have a measurable camber, as shown by the generally arcuate shape of the sheet 102 in FIG. 4.

The first edge detection station 104 may detect the location of the first side edge 110 of the sheet 102 using a first edge detection system 114 and the second side edge 112 of the sheet 102 using a second edge detection system 116. In one aspect, the first edge detection station 104 may generally continuously detect the location of the first and second side edges 110, 112 of the sheet 102. In another aspect, the first edge detection station 104 may periodically (e.g., every 5 seconds) detect the location of the first and second side edges 110, 112 of the sheet 102.

Therefore, as the sheet 102 moves in the longitudinal direction shown by arrow X′, the first edge detection station 104 may determine the width W(x) of the sheet 102 at longitudinal position x by comparing the location of the first side edge 110 with the location of the second side edge 112. The following equation may be used to calculate the width W(x):

W(x)=Y1₁(x)−Y1₂(x) (Eq. 1)

wherein Y1₁(x) is the location (in the y-axis) of the first side edge 110 at longitudinal position x and Y1₂(x) is the location (in the y-axis) of the second side edge 112 at longitudinal position x.

Once the width W(x) of the sheet 102 is known, the following equation may be use to calculate the center point Y1_{C}(x) of the sheet 102 at the first edge detection station 104 at longitudinal position x:

$$Y {1}_{C} ( x ) = 1 / 2 W ( x ) + Y {1}_{1} ( x ) \qquad ( Eq . 2 )$$

wherein Y1₁(x) is the location (in the y-axis) of the first side edge 110 at longitudinal position x.

The second edge detection station 106 may be positioned a predetermined distance L₂ downstream of the first edge detection station 104. For example, the second edge detection station 106 may be positioned about 10 feet downstream of the first edge detection station 104.

The second edge detection station 106 may detect the location of the first side edge 110 of the sheet 102 relative to the process centerline using a third edge detection system 118. However, those skilled in the art will appreciate that whether the system 100 detects the first side edge 110 or the second side edge 112 at the second edge detection station 106 is purely a matter of design choice.

The following equation may be use to calculate the center point Y2_{C}(x) of the sheet 102 at the second edge detection station 106 at longitudinal position x:

$$Y {2}_{C} ( x ) = 1 / 2 W ( x ) + Y {2}_{1} ( x ) \qquad ( Eq . 3 )$$

wherein Y2₁(x) is the location (in the y-axis) of the first side edge 110 at longitudinal position x.

The third edge detection station 108 may be positioned a predetermined distance L₃ downstream of the second edge detection station 106. For example, the third edge detection station 108 may be positioned about 10 feet downstream of the second edge detection station 106. Therefore, the system 100 may track the camber of the sheet at a longitudinal position x relative to a segment of the sheet 102 having a predetermined length L₁ (e.g., 20 feet), wherein L₁ is the sum of L₂ and L₃.

The third edge detection station 108 may detect the location of the first side edge 110 of the sheet 102 relative to the process centerline using a fourth edge detection system 120. However, those skilled in the art will appreciate that whether the system 100 detects the first side edge 110 or the second side edge 112 at the third edge detection station 108 is purely a matter of design choice.

The following equation may be use to calculate the center point Y3_{C}(x) of the sheet 102 at the third edge detection station 108 at longitudinal position x:

$$Y {3}_{C} ( x ) = 1 / 2 W ( x ) + Y {3}_{1} ( x ) \qquad ( Eq . 4 )$$

wherein Y3₁(x) is the location (in the y-axis) of the first side edge 110 at longitudinal position x.

The center points Y1_{C}(x), Y3_{C}(x) at the first and third edge detection stations 104, 108 may define a straight line. Therefore, the camber of the sheet 102 at longitudinal position x may be calculated as the distance between the straight line defined by center points Y1_{C}(x), Y3_{C}(x) and the center point Y2_{C}(x) at the second edge detection station 106.

The collected data points discussed above, as well as the calculated camber, may be presented as a report (e.g., in a table, on a graph or the like).

Although various aspects of the disclosed edge detection system have been shown and described, modifications may occur to those skilled in the art upon reading the specification. The present patent application includes such modifications and is limited only by the scope of the claims.

What is claimed is:

1. A camber tracking system comprising:
an elongated sheet having a first edge and a second edge, wherein said elongated sheet is moving in a traveling direction along a longitudinal axis;
a first edge detecting station comprising a first sensor and a second sensor, wherein said first sensor is positioned relative to said first edge of said elongated sheet and defines a first scan field having a first null zone, said first sensor being moveable relative to said elongated sheet generally perpendicular to said longitudinal axis to align said first null zone with said first edge, and wherein said second sensor is positioned relative to said second edge of said elongated sheet and defines a second scan field having a second null zone, said second sensor being moveable relative to said elongated sheet generally perpendicular to said longitudinal axis to align said second null zone with said second edge;
a second edge detection station displaced from said first edge detection station by a first distance in said traveling direction, said second edge detection station comprising a third sensor positioned relative to said first edge of said elongated sheet, said third sensor defining a third scan field having a third null zone and being moveable relative to said elongated sheet generally perpendicular to said longitudinal axis to align said third null zone with said first edge; and
a third edge detection station displaced from said second edge detection station by a second distance in said traveling direction, said third edge detection station comprising a fourth sensor positioned relative to said first edge of said elongated sheet, said fourth sensor defining a fourth scan field having a fourth null zone and being moveable relative to said elongated sheet generally perpendicular to said longitudinal axis to align said fourth null zone with said first edge.

2. The camber tracking system of claim 1 wherein each of said first, second, third and fourth sensors includes a high speed profile sensor.

3. The camber tracking system of claim 1 wherein said elongated sheet includes a camber associated with a longitudinal position of said elongated sheet, and wherein signals from said first, second and third edge detection station are indicative of said camber at said longitudinal position.

4. The camber tracking system of claim 1 further comprising a processor configured to receive signals from each of said first, second and third edge detecting stations.
